(19) United States
(12) Patent Application Publication
(10) Pub. No.: US 2003/0141269 A1
(43) Pub. Date: Jul. 31, 2003

(54) Letter and number shaped bottle

(76) Inventor: Mikelyn Roderick, Tarzana, CA (US)

Correspondence Address: ALBERT O COTA, 5460 WHITE OAK AVE, SUITE A-331, ENCINO, CA, 91316, US

(21) Appl. No.: 10/033,605

(22) Filed: Jan. 2, 2002

(51) Int. Cl. B65B 7/28; B65D 39/00; B65D 41/00; B67D 3/00

(52) U.S. Cl. 215/44; 215/329; 215/229; 215/388; 222/520; 222/525

(57) ABSTRACT

A letter or number shaped bottle (10) that is filled with a potable fluid (80) such as a natural-spring drinking water or a fruit juice. The letter bottles are constructed of hollow letter shaped structures (12) that range from A to Z, and the number bottles are constructed of hollow number shaped structures (14) that range from 1 to 0, The hollow structures (12, 14) each include an upper bottle opening (36) having integrally attached a tubular neck (38) to which is releasably attached a bottle cap (50) which when removed, the fluid (80) in the bottle can be consumed. Before or after the fluid is consumed the letter bottles can be used as a teaching aid to teach individuals, and particularly school-age children, the alphabet. Likewise, the number bottles can be used to teach correct number sequencing. The invention also includes a tray (70) that allows a set of letter (12), number (14), and/or punctuation mark (15) bottles to be stored or displayed in selected arrangements.

### TECHNICAL FIELD

The invention pertains to the general field of hand-held water bottles, and more particularly to a set of hand-held water bottles that are molded in the shape of the letters of the alphabet or a series of numbers.

### BACKGROUND ART

The need for children to learn at an early age basic tools, such as the alphabet and numbers, is requisite for future learning. Many devices and games have been developed to help facilitate the learning process. Some of these devices attempt to make the learning process fun, while others simply rely on traditional teaching and testing methods. Although tests have been conducted, all that has been learned is that certain children respond better to certain teaching methods. And while it is true that not every child will respond to the same teaching method, it has been found that integrating learning into a child's daily routine, separate from what is perceived as “school”, has been especially beneficial.

If a child is able to pursue his/her daily regimen, including tasks that are considered non-learning, but still being taught at the same time, the results are positive. When a child is able to actually partake of a fundamentally “normal” daily task, such as eating or drinking, the chance of anything learned while at the same time being remembered increases. Since this fact is well known, companies have attempted to create items that will allow a child to learn while they eat or drink. One of the most obvious requirements, from a child's and a parent/teacher's point of view, is that if an item can teach and be fun and entertaining at the same time, the chances of successful learning improve dramatically.

There are a number of items that attempt to teach a child while he/she eats, but not that many that attempt the same when the child is drinking. There are many novelty-type cups, which feature cartoon or other popular characters. Although, these cups/drinking devices have been shown to be very popular with children, there is still a need for an entertaining/fun way of also providing a beverage that will allow a child to learn while also providing enjoyment.

A search of the prior art did not disclose any patents or related articles that read directly on the claims of the present invention. However, the following U.S. patents are considered related:

| PATENT NO. | INVENTOR | ISSUED |
|---|---|---|
| D425, 176 | Besecke | 16 May 2000 |
| D422, 491 | Van Oldenborgh | 11 Apr. 2000 |
| D392, 880 | Fujimoto | 31 Mar. 1998 |

The 425,176 patent discloses a watering can having a duck-shaped spout.

The D422,491 patent discloses a bowling-pin shaped bottle.

D392,880 patent discloses a design which includes a base that supports a whale-shaped bottle.

For background purposes and as indicative of the art to which the invention relates, reference may be made to the following remaining patents found in the search

| PATENT NO. | INVENTOR | ISSUED |
|---|---|---|
| D388, 708 | Monaghan | 6 Jan. 1998 |
| D361, 788 | Melzian, et al | 29 Aug. 1995 |
| D132, 619 | Flaster | 1 Jun. 1942 |

### DISCLOSURE OF THE INVENTION

The letter and number shaped bottles are produced in all of the upper and lower case letters of the English alphabet (A to Z), and numbers ranging from 1 to 0. Each bottle is dimensioned to hold up to 8-ounces of a potable fluid that typically consists of natural-spring drinking water or a fruit juice.

In its most basic design configuration, the letter and number shaped bottles comprise:

A set of hollow structures that are molded in the shape of the letters of the alphabet or in the shape of numbers. Each letter and number structure includes an upper surface and a lower surface, with the upper surface having a bottle opening,

A tubular neck having an upper edge and a lower edge, wherein the lower edge in integrally molded over the bottle opening, and

A bottle cap realeaseably attached to the upper edge of said tubular neck,

wherein when the cap is removed the potable fluid can be consumed.

Before or after the potable fluid is consumed, the letter bottles can be used by teachers as an aid to teach individuals, and especially school children, to learn the alphabet. Likewise, the number bottles can be used to teach children correct number sequencing. After the liquid has been consumed, the bottles can be filled with colored water or a granular substance such as colored sand or beads. This post-drinking addition adds to the usefulness of the letter and number bottles in that they are made more attractive to children. To further facilitate the teaching period, a partitioned tray can be utilized to store or to place the letter and number bottles in selected arrangements.

In view of the above disclosure, it is the primary object of the invention to produce a set of alphabet and number shaped bottles that are filled with a potable fluid. The bottles are designed to be used, before or after the fluid is consumed, by teachers to teach children the alphabet and number sequencing.

In addition to the primary object of the invention, it is also an object of the invention to produce alphabet and number shaped bottles that:

Can be dimensioned to contain various amounts of fluids with 8-ounces preferred.

After the initial fluid consumption, the attractiveness of the bottles can be enhanced by filling them with various substances including a colored liquid, sand and beads.

Encourages young children to drink more water.

Can be constructed of a washable, refillable, and biodegradable plastic.

Is amenable for use as a premium item.

Can be embellished with various symbols and phrases that represent seasonal holidays.

Can assist in building a child's self esteem and confidence level.

Is cost effective from both a manufacturing and consumer points of view.

These and other objects and advantages of the present invention will become apparent from the subsequent detailed description of the preferred embodiment and the appended claims taken in conjunction with the accompanying drawings.

### BRIEF DESCRIPTION OF THE DRAWINGS

FIG. 1 is a sequential diagram illustrating the letters of the English alphabet that are utilized in molding the letter shaped bottles.

FIG. 2 is a sequential diagram illustrating the numbers that are utilized in molding the number shaped bottles.

FIG. 3 is a front elevational view of a letter bottle that includes indicia and a gripping section.

FIG. 4 is a front elevational view of a number bottle which includes indicia and a gripping section.

FIG. 5 is a top plan view of an “A” shaped letter bottle showing a bottle opening located on the letter's upper surface.

FIG. 6 is a front elevational view of an “A” shaped letter bottle having attached a threaded tubular neck extending upward from the bottle opening.

FIG. 7 is a side elevational view of a threaded twist-off cap.

FIG. 8 is a side elevational view of a threaded pop-up cap.

FIG. 9 is a side elevational view of a threaded lift-tab cap.

FIG. 10 is a top plan view of a tray that includes a set of partitions into which are realeasably inserted a group of letters and/or numbers.

### BEST MODE FOR CARRYING OUT THE INVENTION

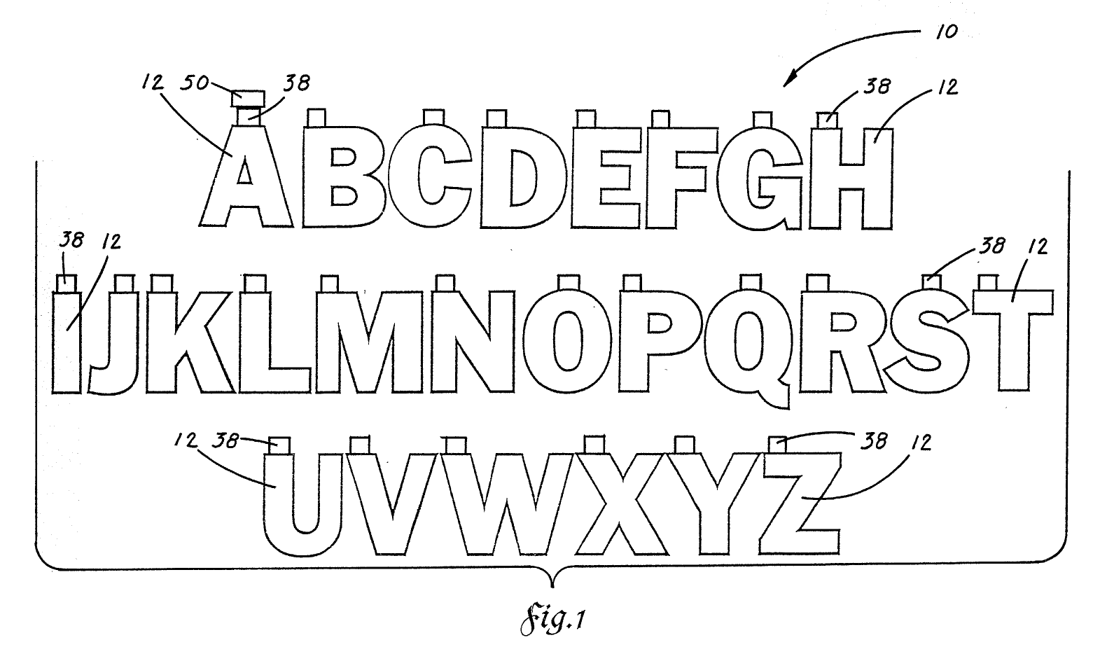

The best mode for carrying out the invention is presented in terms of a preferred embodiment for a letter or number shaped bottle that is dimensioned to contain a potable fluid 80. The preferred embodiment, as shown in FIGS. 1-10, is comprised of the following major elements: a bottle 10 consisting of a hollow letter shaped structure 12 or a hollow number shaped structure 14, a tubular neck 38, and a bottle cap 50.

The bottle 10 is designed to be produced in the English or various foreign alphabets having letters and/or numbers that can be selected from various font designs. However, for brevity the following description of the invention will be limited to the English alphabet which is presented in capital and lower case Arabic letters that range from A to Z , as shown in FIG. 1 and 10, and numbers that range from 1 to 0, as shown in FIG. 2.

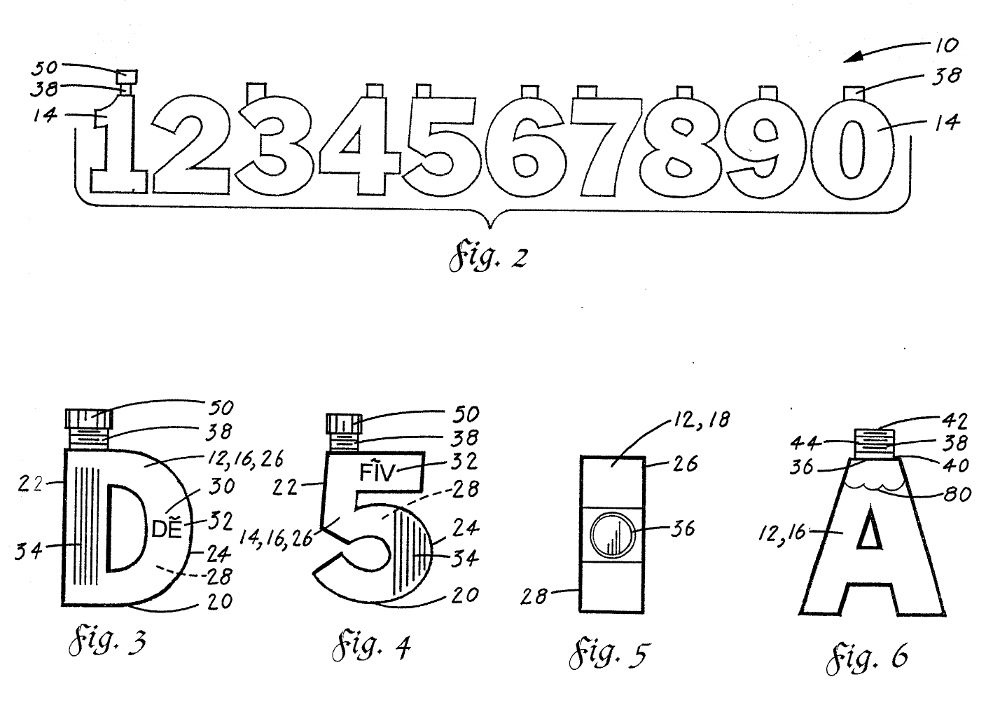

Each letter and number is comprised of a hollow structure 16 that is molded of a substantially rigid transparent or translucent plastic that is dimensioned to hold from seven to nine ounces, and preferably eight ounces, of a potable fluid 80. Each hollow structure 16, representing a letter 12, a number 14, or a grammatical punctuation mark 15, has, depending on its configuration, at least one upper surface 18, at least one lower surface 20, at least one left surface 22, at least one right surface 24, a front surface 26, and a rear surface 28. The front surface 26, as typically shown in the letter of FIG. 3 and in the number of FIG. 4, includes an indicia area 30. The indicia area can be printed, embossed or raised with a word, such as the phonetic pronunciation 32 of the letter or number, or a related character that will help a child to correctly learn and pronounce each of the letters and numbers. The front surface 26 can also be designed to include a gripping area 34, as also shown in FIGS. 3 and 4, that can consist of a set of serrations or indentations.

On one of the upper surfaces 18 of each letter 12, number 14 or punctuation mark is located a bottle opening 36 as shown in FIG. 5. To the opening 36 is integrally molded the lower edge 40 of the tubular neck 38, as shown in FIG. 6. Adjacent the upper edge 42 of the neck 38 is located a set of external threads 44 that are dimensioned to releasably attach a bottle cap 50 having a set of corresponding internal threads.

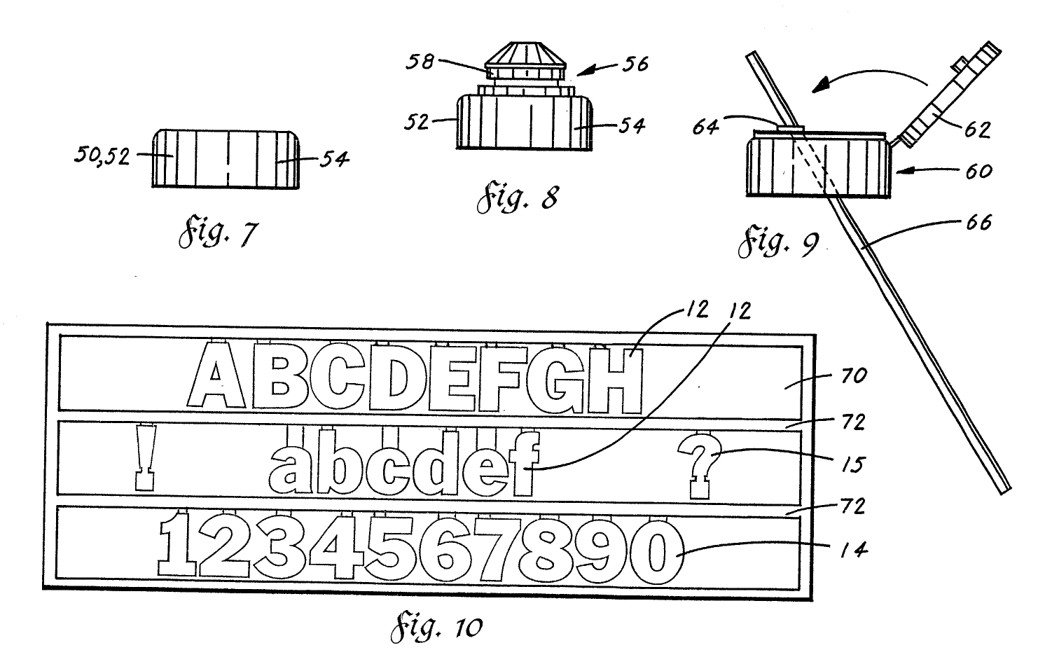

The bottle cap 50 can be selected from various designs. In FIG. 7, the cap 50 is comprised of a threaded twist-off cap 52 which preferably includes on its side a multiplicity of gripping serrations 54. In FIG. 8 is shown a pop-up cap 56 of the type that incorporates a threaded twist-off cap 52 and a pop-up section 58, that when placed in an upper position the fluid 80 in the bottle 12 or 14 can be dispensed . In FIG. 9, is shown a threaded lift-tab cap 60 that incorporates a normally-closed lift-tab 62 that covers a cap opening 64. When the lift-tab 62 is lifted, the fluid can be dispensed from the cap opening 64 or a straw 66, as also shown in FIG. 9, can be inserted into the cap opening to allow the fluid to be sucked through the straw 66. The placement of the bottle opening 36, the tubular neck 38 and the cap 50 is dependent upon the configuration of the letter 12 or number 14. In FIGS. 1 and 2 are shown typical locations where a tubular neck 38 and cap 50 can be located.

The letter bottles 12 and the number bottles 14 are preferably molded of either a translucent or transparent substantially rigid plastic and are initially filled with the potable fluid 80 that preferably consists of a natural-spring drinking water or a fruit juice. After the fluid 80 is consumed, the bottles 12,14 can be refilled with colored water or a granular substance such as colored sand, beads, or any other substance that adds color to the bottles. The addition of the color enhances the attractiveness of the bottles, especially for children. Whether the bottles are filled with a fluid or a granular substance, they are used by teachers as an aid to teach individuals, and in particular school age children, to learn the correct sequencing of the alphabet and the numbers. To further provide a teacher with a learning aid, the invention includes a tray 70 having a plurality of partitions 72. The tray 70, as shown in FIG. 10, allows a group of letters 12, numbers 14 and/or grammatical punctuation marks 15 to be stored or displayed in selected arrangements.

While the invention has been described in complete detail and pictorially shown in the accompanying drawings it is not to be limited to such details, since many changes and modifications may be made to the invention without departing from the spirit and the scope thereof For example, in addition to the above described capital letters and numbers, lower-case letters and grammatical punctuation marks can also be configured as bottles, the bottles can also be molded of glass and be tinted, or molded with a textured surface. Hence, the application is described to cover any and all modifications and forms which may come within the language and scope of the claims.

1. A set of letter shaped bottles dimensioned to contain a potable fluid, said bottles comprising:
a) a set of hollow structures molded in the shape of the letters of the alphabet, wherein each said letter structure includes an upper surface and a lower surface, with the upper surface having a bottle opening,
b) a tubular neck having an upper edge and a lower edge, wherein the lower edge is integrally molded over the bottle opening, and
c) a bottle cap releasably attached to the upper edge of said tubular neck, wherein before or after the potable fluid is consumed, the letter shaped bottles can be used as a teaching aid to teach the alphabet.

2. A set of letter or number shaped bottles dimensioned to contain a potable fluid, wherein each said letter or number comprises:
a) a hollow structure having at least one upper surface, at least one lower surface, at least one left surface, at least one right surface, a front surface and a rear surface,
b) a bottle opening located on the at least one upper surface,
c) a tubular neck having an upper edge and a lower edge, wherein the lower edge is integrally molded over the bottle opening, and
d) a bottle cap having means for being releasably attached to the upper edge of said tubular neck, wherein before or after the potable fluid is consumed, the letter or number shaped bottles can be used as a teaching aid to teach children the correct sequencing of the alphabet and the numbers.

3. The bottles as specified in claim 2 wherein said letter or number shaped structures are molded of plastic or glass.

4. The bottles as specified in claim 3 wherein said bottles are dimensioned to hold from 7to 9 ounces of fluid.

5. The bottles as specified in claim 2 wherein the upper edge of said tubular neck further comprises a set of external threads.

6. The bottles as specified in claim 5 wherein said bottle cap further comprises a set of internal threads which provide said means for being releasably attached to the upper edge of said tubular neck.

7. The bottles as specified in claim 6 wherein said bottle cap is comprised of a threaded twist-off cap.

8. The bottles as specified in claim 7 wherein said twist-off cap further comprises a multiplicity of gripping serrations.

9. The bottles as specified in claim 6 wherein said bottle cap is comprised of a pop-up cap having a threaded twist-off cap and a pop-up section that when placed in an upper position the fluid in said bottle can be dispensed.

10. The bottles as specified in claim 6 wherein said bottle cap is comprised of a threaded lift-tab cap that incorporates a normally-closed lift-tab that covers a cap opening, wherein when said tab is lifted, the bottle opening is exposed allowing the fluid in said bottle to be dispensed.

11. The bottles as specified in claim 10 further comprising a drinking straw dimensioned to fit into the cap opening on said threaded lift-tab cap.

12. The bottles as specified in claim 2 wherein said letter bottles are produced in a set which comprises all the letters of the alphabet.

13. The bottles as specified in claim 12 wherein said alphabet is comprised of capital arabic letters ranging from A to Z.

14. The bottles as specified in claim 2 wherein said alphabet is comprised of lower case letters ranging from a to z.

15. The bottles as specified in claim 2 wherein said bottles are produced in a set which comprises grammatical punctuation marks.

16. The bottles as specified in claim 2 wherein said number bottles are produced in a set of numbers ranging from 1 to 0.

17. The bottles as specified in claim 2 wherein the front surface of said bottles further comprises an area onto which can be applied indicia.

18. The bottles as specified in claim 2 wherein said potable fluid is comprised of a natural-spring drinking water or a fruit juice.

19. The bottles as specified in claim 2 further comprising a tray having a plurality of partitions which allows a group of letters and/or numbers to be stored, or displayed in a selected arrangement.

20. An alphabet teaching aid comprising:
a) a set of hollow letter shaped structures that range from A to Z and that are initially filled with a potable fluid, wherein when the potable fluid is consumed, the structures can be refilled with a colored substance to add to the attractiveness of the letter structures, wherein each said letter structure includes an upper surface and a lower surface, with the upper surface having a bottle opening,
b) a tubular neck having an upper edge and a lower edge, wherein the lower edge is integrally molded over the bottle opening, and
c) a bottle cap realeasably attached to the upper edge of said tubular neck.
